(19) United States
(12) Patent Application Publication
(10) Pub. No.: US 2015/0027381 A1
(43) Pub. Date: Jan. 29, 2015

(54) CLUMPING ANIMAL LITTER COMPOSITIONS

(71) Applicant: KMI ZEOLITE INC., Calgary (CA)

(72) Inventor: LuVerne E.W. Hogg, Peachland (CA)

(21) Appl. No.: 14/384,579

(22) PCT Filed: Mar. 15, 2013
(86) PCT No.: PCT/CA2013/000249

§ 371 Date: Sep. 11, 2014

Related U.S. Application Data
(60) Provisional application No. 61/611,906, filed on Mar. 16, 2012.

(51) Int. Cl. A01K 1/015

(52) U.S. Cl. CPC A01K 1/0155; A01K 1/0154
USPC 119/171

(57) ABSTRACT

A clumping animal litter composition comprising zeolite, a surface-active agent and a clumping agent is provided. Methods of making the clumping animal litter composition are also provided. The method comprises coating the surface of zeolite with a surface-active agent and subsequently adding a clumping agent to the coated zeolite.

### CROSS-REFERENCE TO RELATED APPLICATIONS

This application claims the benefit of U.S. Provisional Patent Application No. 61/611,906, filed Mar. 16, 2012, which is herein incorporated by reference.

### FIELD OF THE INVENTION

The field of the invention is clumping animal litter compositions and methods of making these compositions.

### BACKGROUND OF THE INVENTION

According to statistics provided by the Humane Society of the United States, there are approximately 86.4 million cats owned in the United States alone. Approximately thirty-three percent of households in the U.S. own at least one cat. These animals require a controlled indoor location in which to eliminate their waste.

In recent years, “clumping” cat litters, that “capture” the urine in a “ball” or “clump” of litter which can then be scooped from the non-moistened litter for easy removal, have become very popular with consumers who purchase pet care supplies. When both types of waste are regularly removed from the litter and waste smells are reduced, cats are more likely to consistently use the litter, and are less likely to practice inappropriate elimination outside the litter area (e.g., a litter box). Regular removal of both types of waste also greatly reduces the unpleasant odors associated with animal waste.

While clumping litters have been a vast improvement in eliminating animal waste before it generates objectionable odors and inappropriate elimination behaviors by animals, these clumping litters still possess one or more undesirable properties or characteristics. These include: poor urine absorption; low odor adsorption; poor clumping of the moistened litter, resulting in difficulties in removing the clumps from the litter; and ineffective isolation of the animal's liquid waste, resulting in microbial activity and resultant odors. In addition, from an economic standpoint, it would be advantageous if the litter was formulated such that the animal waste could be removed, while allowing as much of the litter to remain behind for future use as possible. There is still a need for an improved clumping animal litter that eliminates or reduces the odors associated with animal urine and/or allows the litter to be cleaned more easily and/or is formulated to permit as much litter as possible to be left behind for future uses by the animal.

### BRIEF SUMMARY OF THE INVENTION

The present invention features a clumping animal litter composition comprising: zeolite, a surface-active substance and a clumping agent. The zeolite is coated with the surface-active substance, and then with the clumping agent. In one embodiment, the clumping animal litter composition is a clumping cat litter composition.

In one embodiment, the zeolite is naturally-occurring. The naturally-occurring zeolite may be, for example, Analcime, Apophyllite, Chabazite, Clinoptilolite, Epistilbite, Faujasite, Gmelinite, Heulandite, Laumontite, Merlinoite, Mesolite, Mordenite, Natrolite, Scolecite, Stellarite, Stilbite or Thompsonite. The zeolite may also be a combination of one or more zeolites. In one embodiment, the zeolite is Clinoptilolite.

The zeolite can have a purity of between about 50% and about 98%. In one embodiment, the zeolite has a purity of between about 96% and about 98%. In another embodiment, the zeolite has a purity of about 96%. Preferably, the zeolite has a gradation of −8+50 mesh (ASTM). In another embodiment the zeolite has less than about 3% fines (i.e., less than about 3% of the zeolite passing through the −50 mesh). In one embodiment, the zeolite has a −20+50 gradation with less than 3% fines. The zeolite can have a moisture content of about 1% to about 5%. In one embodiment, the moisture content is about 4% to about 5%. In another embodiment, the zeolite has a moisture content of between greater than 5% and about 8%.

The surface-active substance (surfactant) can be sodium sulfate, potassium sulfate, sodium phosphate (dibasic or monobasic), sodium pyrophosphate, sodium carbonate, potassium stearate, aluminum potassium sulfate or aluminum sulfate, or a combination of one or more of these compounds. In one embodiment, the surface-active substance is sodium sulfate or potassium sulfate. In another embodiment, when the zeolite has a moisture content of greater than 5%, the sodium sulfate is anhydrous sodium sulfate.

The clumping agent can be psyllium, agar, algin, carrageenan, guar gum, gum arabic, gum ghatti, gum tragacanth, karaya gum, larch gum, locust bean gum, pectin, quince seed gum, tamarind gum or xanthan gum or a combination of one or more of these compounds. The clumping agent may also comprise ground vegetative material from the Plantago or Cydomia family. In one embodiment, the clumping agent is psyllium. In other embodiments, the psyllium has a purity of about 70% to about 95% and/or a mesh size of 40−.

The zeolite may be present in the composition at a weight percent of between about 50 and about 98%. In one embodiment, the zeolite is present at a weight percent of between about 90% and about 98%. In another embodiment, the zeolite is present at a weight percent of about 92%. The clumping agent may be present in the composition at a weight percent of about 1% to about 7%. In one embodiment, the clumping agent is present at about 2% by weight. The surface-active agent may be present in the final composition at a range of about 1% to about 8% by weight. In one embodiment, the surface-active agent is present in the final composition at a range of about 1% to about 5% by weight. In another embodiment, the surface-active agent is present in the final composition at about 2% by weight. In another embodiment, the surface-active agent is present in the final composition at between greater than about 5% and about 8%.

The compositions of the present may also further comprise a fragrance.

In an embodiment, the clumping animal litter composition may comprise, by weight, about 2% sodium sulphate (which may be anhydrous), about 2% psyllium (or another clumping agent), about 4% water and about 92% zeolite. In another embodiment, the clumping animal litter composition may comprise, by weight about 1% anhydrous sodium sulphate, about 2% psyllium, about 6% water and about 91% zeolite. In further embodiments the zeolite has purity of 96%, a −20+50 gradation and/or 3% or less fines.

In another embodiment, the animal litter is a cat litter.

In another embodiment, the clumping animal litter of the present invention, further comprises an additional animal litter. In one embodiment, the additional animal litter is a bentonite-containing animal litter. In one embodiment, the ratio of zeolite-containing clumping animal litter to the additional animal litter is 10%:90%; 20%:80%,; 30%:70%; 40%:60%, 50%:50%; 60%:40%; 70%:30%; 80%:20% or 90%:10% by weight.

In another aspect, the invention features a method of making a clumping animal litter composition as described above. The method comprises coating zeolite with a surface-active agent; and adding a clumping agent to the surface-coated zeolite produced in the previous step. In one embodiment, the zeolite is dried prior to surface-coating it. The zeolite may be dried to have a moisture content of between about 1% and about 5%. In one embodiment, the zeolite has or has been dried to have a moisture content of about 4%. The surface-active agent can be applied using a sprayer. In one embodiment, the sprayer is a high pressure sprayer. In another embodiment, the zeolite and surface-active agent are mixed by agitation. and/or the surface-coated zeolite and clumping agent are mixed by agitation.

In another aspect, if the moisture content is above 5% (for example, 6%, 7% or 8%) the surface-active agent is added dry. The clumping agent can then be added and the mixture agitated again to produce the final clumping litter composition.

In other embodiments, the method is performed using zeolite, surface-active agent and clumping agent as described above.

The clumping animal litter compositions of the present invention may have a number of advantages. The compositions utilize high levels of zeolite, providing exceptional odor control. This is a benefit to both the animal, who will be less likely to engage in inappropriate elimination behavior, and the owner, who does not have to smell the unpleasant odor of animal waste and does not have to clean up after an animal engaging in inappropriate elimination. The compositions may also offer more volume by weight than other clay litter compositions, such as bentonite-based clumping animal litters on a pound by pound basis. This means that less of the composition will be required in animal litter boxes, compared to other types of animal litter compositions.

In addition, when a litter composition is made up of bentonite, the size of the clump is determined by the swelling capacity of the particular bentonite, which varies. In the animal litter compositions of the present invention, the expansion of the litter is controlled by the amount of clumping agent used. In the present invention, the zeolite clumps are smaller for the same volume of liquid waste (i.e., urine). Also, the zeolite has a rigid microporous structure which takes the animal liquid waste into the structure without swelling; the only swelling is from the clumping agent which holds the saturated grains of zeolite together, resulting in smaller clumps than with other litter compositions comprising, for example, bentonite, and more efficient utilization of the litter. In addition, as the liquid waste (e.g., urine) has time to penetrate into the molecular cavities in the zeolite, resulting in the zeolite's surface porosity subsequently pulling the liquid waste from surrounding clumping agent, the clump shrinks again. The occurrence of smaller clumps results in less clumped litter needing to be removed from the litters compared to bentonite-based litters, thereby resulting in overall cost savings to the human consumer purchasing pet care supplies.

Other advantages are that the clumps are competent and can be removed in a matter of minutes and after a few hours are very hard and durable making collection and disposal more efficient. Finally, the zeolite litter compositions of the present invention effectively isolate the urine in minutes, reducing microbial activity and resultant odors for a healthier litter and less inappropriate elimination behavior by the animal.

### DETAILED DESCRIPTION OF THE INVENTION

The present invention features a clumping animal litter composition comprising: zeolite, a surface-active agent and a clumping agent. The zeolite is coated with the surface-active agent, and then with the clumping agent. This composition clumps when wetted by an animal. The clumps absorb the liquid and the odors associated with such liquids. The clumps can then be removed from the animal litter composition, thereby greatly reducing or eliminating odors caused by animal waste build-up.

Zeolite is a microporous material that has absorbent and adsorbent properties. Therefore, it can be used in the present compositions to absorb and adsorb odors arising from animal waste. The zeolite of the present invention may be naturally-occurring. Examples of naturally-occurring zeolite, are known to those skilled in the art and include, Analcime, Apophyllite, Chabazite, Clinoptilolite, Epistilbite, Faujasite, Gmelinite, Heulandite, Laumontite, Merlinoite, Mesolite, Mordenite, Natrolite, Scolecite, Stellarite, Stilbite and Thompsonite. The zeolite may also be a combination of one or more zeolites. In one embodiment, the zeolite is Clinoptilolite.

It is understood that various types of zeolite, for example, those described above, can contain varying amounts of actual zeolite. The purity of zeolite can be measured using techniques known in the art, for example, x-ray diffraction. When using x-ray diffraction, the standard error for zeolites is typically ±3%. The zeolite of the present invention can have a zeolite purity of between about 50% and about 98% (e.g., 95%±3%). For example, the purity of the zeolite can be between 55% and 98%; 60% and 98%, 65% and 98%, 75% and 98%, 80% and 98%, 85% and 98%, 90% and 98%, 95% and 98%, or at about 97% or 98%. In one embodiment, the zeolite is 96% pure.

Dust is an element of animal litter that consumers generally find undesirable in an animal litter product. The compositions of the present invention have low dust. For example, preferably, the zeolite has a gradation of −8+50 mesh, with less than 3% fines (dust) (ASTM) (meaning that 97% or more of the zeolite particles are retained by a 50 mesh (ASTM) sieve and pass through an 8 mesh (ASTM) sieve). Fines are measured by determining the percent of the zeolite passing through a 50 mesh (ASTM) sieve. The zeolite can have, for example, a −20+50 gradation with less than 3% fines (meaning that 97% or more of the zeolite particles are retained by a 50 mesh (ASTM) sieve and pass through a 20 mesh (ASTM) sieve). The moisture content of the zeolite can be about 1% to about 5%, for example, 1%, 2%, 3%, 4% or 5%. In one embodiment, the moisture content is about 4% to about 5%. The zeolite can be dried to a desired moisture content level, using standard methods known in the art, prior to using it to make the compositions of the present invention. The zeolite can also have a moisture content of greater than 5%, for example, 6%, 7% or 8%, in which case the surface-active agent should be added in the dry anhydrous form.

The surface-active agent can be sodium sulfate, potassium sulfate, sodium phosphate (dibasic or monobasic), sodium pyrophosphate, sodium carbonate, potassium stearate, aluminum potassium sulfate or aluminum sulfate. In one embodiment the surface-active agent is sodium sulfate or potassium sulfate. In another embodiment, when the zeolite has a moisture content of greater than 5%, the sodium sulfate is anhydrous sodium sulfate. These materials are preferably substantially non-toxic, and/or food grade, for example, meeting the Food Chemicals Codex specifications. Such surface active agents are commercially available.

The clumping animal litter of the present invention also comprises a clumping agent. Clumping agents are additives that can be added to inherently non-clumping or poorly-clumping materials to create a litter material that behaves like a clumping absorbent material, for example, upon contact with a liquid such as urine, the litter material readily agglomerates with other moistened litter material, forming a clump. Clumping agents are known in the art and are described, for example, in Kirk-Othmer Encyclopaedia of Chemical Technology, Third Edition, Vol. 12 pp 45-66, the teachings of which are incorporated herein by reference. Examples of clumping agents include psyllium, agar, algin, carrageenan, Cydonia, guar gum, gum arabic, gum ghatti, gum tragacanth, karaya gum, larch gum, locust bean gum, pectin, Plantago, quince seed gum, tamarind gum and xanthan gum. Ground vegetative material from the Plantago family in particular has been found to form a particularly effective clumping agent. The Cydonia family of gum containing agents is an equivalent of the Plantago family of gum containing plants. As an equivalent, agents formed from the Cydonia family are expected to perform similarly to Plantago clumping agents. A combination or one or more clumping agents may also be used. In one embodiment, the clumping agent is psyllium. The psyllium can have a purity of about 70% to about 95%. Preferably, the psyllium has a size of 40−mesh (ASTM). Such clumping agents are commercially available at various pre-determined purities.

The zeolite may be present in the composition at a weight percent of about 50% to about 98%. For example, the zeolite may be present in the composition at a weight percent of about 90% to about 98%, for example at 90%, 91%, 92%, 93%, 94%, 95%, 96%, 97% or 98%. In one embodiment, the zeolite is present at about 92% by weight. In another embodiment, the zeolite is present at about 91% by weight. Those skilled in the art will understand that the amount of zeolite used in the clumping animal litter of the present invention will depend on the purity of the zeolite used. The weight percent of the zeolite of the present invention refers to the actual weight percent of zeolite in a zeolite compound, such as those described above. High purity zeolite compounds, such as Clinoptilolite (e.g., 96% pure), contain more zeolite per unit weight compared to zeolite compounds that are less pure.

The clumping agent may be present in the composition at a weight percent of about 1% to about 7%, for example, at 1%, 2%, 3%, 4%, 5%, 6% or 7%. Again, those skilled in the art will understand that the amount of clumping used in the clumping animal litter of the present invention can, if desired, be based on the purity of the clumping agent used in that instance. In one embodiment, the clumping agent is present in the final composition at about 2%. The surface-active agent may be present in the final composition at a range of about 1% to about 6%. In one embodiment, the surface-active agent is present in the final composition at about 2%. In another embodiment, the surface-active agent is present in the final composition at about 6%.

A composition may contain, by weight, about 2% sodium sulphate, about 2% psyllium, about 4% water and about 92% zeolite. The amount of sodium sulphate in the composition may be increased, for example, up to 8%, while reducing the content of the zeolite and/or water components in the composition on a pro-rata basis. When the sodium sulphate content increases beyond 5%, anhydrous sodium sulphate should be used. Similarly, the amount of psyllium in the composition may be increased, for example, up to 7%, while reducing the content of the zeolite component in the composition on a pro-rata basis.

A composition may also contain zeolite of −20+50 gradation with less than 3% fines, at approximately 98% by weight, mixed with anhydrous sodium sulfate (1% by weight) and psyllium (1% by weight, 70-95% pure, mesh size 40−). The zeolite may be of purity of 96%, 97% or 98%.

The composition may contain, for example, 2% sodium sulfate in solution, which is dried to a total moisture of 4% in the zeolite prior to adding 2% clumping agent. The net weight of this composition is 2% clumping agent, 2% sodium sulfate, 4% water and 92% zeolite (with a 96% purity).

If desired, additional agents can be added to the composition of the present invention. For example, a fragrance, such as an aromatic or an essential oil can be added to the composition to provide the composition with a particular scent. The scent, may provide, for example, a freshness or deodorizing impression to the animals using the composition and/or to the humans smelling it. Such fragrances are known to those skilled in the art and can be present in the composition at a concentration of about 0.001% to 0.05% by weight.

The zeolite-containing clumping animal litter of the present invention can be combined with an additional animal litter, for example, a bentonite-containing animal litter. The ratio of zeolite-containing clumping animal litter to the additional animal litter can be, for example, 10%:90%; 20%:80%,; 30%:70%; 40%:60%, 50%:50%; 60%:40%; 70%:30%; 80%:20% or 90%:10% by weight. In such litter products, the zeolite-containing clumping litter provides the advantages described herein to the other animal litter.

While not wishing to be held to any hypothesis, it is thought that the compositions of the present invention have the advantages discussed herein in part because the surface-active agent changes the charge on the surface of the zeolite so that the clumping agent, for example, psyllium binds better to it. The compositions also have these advantages due to the physical chemistry of the compositions. For example, the surface tension created by adding the surface-active agent in liquid form creates an inward pressure, which restrain liquids, containing urea, for example, from the animal urine, from flowing. This then allows the clumping agent, for example, psyllium to expand and adsorb more animal waste.

The invention also features methods of making the clumping animal litter composition described herein. The method comprises surface-coating zeolite with a surface-active agent; and adding a clumping agent to the surface-coated zeolite. The zeolite may be dried prior to surface-coating it, using methods known in the art. The zeolite may be dried to have a moisture content of between about 1% and about 5%, for example, 1%, 2%, 3%, 4% or 5%. Methods for determining the moisture content of the zeolite are known to those skilled in the art. One preferred moisture content level of the zeolite is about 4% to about 5%.

The surface-active agent can be applied to the zeolite using a sprayer. There are many sprayers known to those skilled in the art that provide a fine spray or mist to the zeolite. For example, the sprayer may be a high pressure sprayer or can be a hand-operated sprayer. The mixture of zeolite and surface-active agent can be mixed by gentle agitation during the coating process. There are many ways in which the agitation can occur. For example, an industrial grade blender, such as a ribbon blender, V blender, cone screw blender, screw blender, double cone blender, or drum blender or a mixer, such as a paddle mixer can be used. Once sprayed, the surface-coated zeolite may be allowed to stand to ensure moisture dispersion consistency in the compound prior to adding the clumping agent. However, depending on the method used to spray the zeolite, it may not be necessary to allow the zeolite to stand prior to adding the clumping agent. If desired, the moisture content of the surface-coated zeolite can be measured a second time, prior to addition of the clumping agent.

Zeolite having a moisture content greater than 5%, for example 6%, 7% or 8% can also be used to make the clumping animal litter composition of the present invention. In such instances, rather than coating the zeolite with a liquid form of the surface-active agent, the surface-active agent, in its dry anhydrous form, can be combined with the zeolite and mixed to coat the zeolite with the surface-active agent. Mixing can occur by agitation as described above.

The clumping agent is then added to the surface-coated zeolite and the mixture is agitated once again, to produce the final clumping animal litter composition. The moisture content of the final product should be between about 1% and about 8%, for example, about 4%.

The zeolite-containing clumping animal litter of the present invention can also be combined with other animals litters, for example, a bentonite-containing animal litter. The ratio of zeolite-containing clumping animal litter to the additional animal litter can be for example 10%:90%; 20%:80%,; 30%:70%; 40%:60%, 50%:50%; 60%:40%; 70%:30%; 80%:20% or 90%:10% by weight.

The invention is further defined by reference to the following examples describing in detail the preparation of compositions of the invention. It will be apparent to those skilled in the art that many modifications, both to materials and methods, may be practiced without departing from the purpose and interest of this invention. The following examples are set forth to assist in understanding the invention and should not be construed as specifically limiting the invention described and claimed herein. Such variations of the invention, including the substitution of all equivalents now known or later developed, which would be within the purview of those skilled in the art, and changes in formulation or minor changes in experimental design, are to be considered to fall within the scope of the invention incorporated herein.

### EXAMPLES

### Example 1

### Preparation of Animal Litter 1

The clumping animal litter of the present invention was manufactured as follows. Clinoptilolite zeolite (KMI Zeolite, Inc., Sandy Valley, Nev.) (at least 96% pure, having a −20+50 mesh gradation, and containing less than 3% fines) was used as the starting material. Anhydrous sodium sulfate was added into 90-100° F. water at a concentration of 20%. The sodium sulfate solution was then applied using a high-pressure sprayer with misting nozzles to the zeolite using a 2% aqueous solution while agitating the mixture to ensure proper surface coating of the zeolite. The coated zeolite was then allowed to stand for one half hour to ensure moisture dispersion consistency in the compound. Moisture levels were then tested and confirmed to be 5% or less. The compound was then mixed again and commercially available psyllium (2% by weight; 70-95% pure, mesh size 40−) was then added to the compound while it continued to mix. The product was then fed into a hopper and packaged. The net weight of this composition was 2% psyllium, 2% sodium sulfate, 4% water and 92% zeolite (with a 96% purity).

### Example 2

### Preparation of Animal Litter 2

The clumping animal litter of the present invention was also manufactured as follows. Clinoptilolite zeolite (KMI Zeolite, Inc., Sandy Valley, Nev.) (at least 96% pure, having a −20+50 gradation, and containing less than 3% fines) was used as the starting material. Anhydrous sodium sulfate (saltcake grade), commercially available, was added into 90-100° F. water at a concentration of 20%. The sodium sulfate solution was then applied by spraying it from a spray bottle with a misting nozzle to the zeolite using a 2% aqueous solution while gently blending the mixture to ensure proper surface coating of the zeolite. Commercially available psyllium (2% by weight; 70-95% pure, mesh size 40−) was then added to the compound while it continued to mix, resulting in the finished product. The net weight of this composition was 2% psyllium, 2% sodium sulfate, 4% water and 92% zeolite (with a 96% purity).

### Example 3

### Preparation of Animal Litter 3

The clumping animal litter of the present invention was also manufactured as follows. Clinoptilolite zeolite (KMI Zeolite, Inc., Sandy Valley, Nev.) (at least 96% pure, having a −20+50 mesh gradation, and containing less than 3% fines) was used as the starting material. The moisture content of the zeolite was between 5% and 8%. Anhydrous sodium sulfate (2% by weight), in dry form, was then applied to the zeolite while mixing the reagent by agitation to ensure proper surface coating of the zeolite. The compound was then mixed again and commercially available psyllium (2%; 70-95% grade, mesh size 40−) was then added to the compound while it continued to mix. The product was then fed into a hopper and packaged. The net weight of this composition was 2% psyllium, 2% anhydrous sodium sulfate, 5% to 8% water and 88% to 91% zeolite (with a 96% purity).

### Example 4

### Testing of Animal Litter

### Test Criteria, Protocol and Procedures

A single, mature house cat, female and spayed, used to using Bentonite clumping litter was the test cat for this study.

A standard cat box, 16″ long and 12″ wide, was used. The clumps were removed daily, measured for length and width, and weighed. The target for the number of clumps in the test was 50. The stools were removed daily and discarded. The clumps were contained and retained for examination.

### Part 1

During the first part of the trial, the zeolite clumping litter made, for example, according to the process set out in Example 1, containing 2% by weight sodium sulfate, 2% by weight psyllium, 4% water and 92% (−20+50) zeolite was used. The zeolite had a purity of 96% and contained less than 3% fines. The quantity of zeolite clumping litter in the cat box was maintained at three to four inches. Fifty (50) clumps were collected. These clumps were removed, weighed, measured, and stored. Further, the clumps were tested for smell and for strength of the clump (which factored into the ease of removing the clump from the litter). Smell was assessed by smelling the clump, the smeller's nose being positioned a set distance away and determining the intensity of the odor of the clumps.

### Part 2

During the second part of the trial, the cat box contents were changed to a sodium bentonite litter, which was a common big box store product, having a mesh size of −8+40 (ASTM). The bentonite had a reported fragrance added. The quantity of bentonite in the cat box was maintained at three to four inches. Fifty (50) clumps were collected. These clumps were removed, weighed, measured, and stored. Further, the clumps were tested for smell and for strength of the clump, as described above.

### Part 3

The third part of the trial involved providing the choice of two cat boxes, one filled with zeolite clumping litter described above in Part 1, the second filled with the bentonite clumping litter described above in Part 2. The two boxes were placed side by side for one week, at which time the placement of the boxes was switched for one week. All clumps were removed, weighed, measured, and stored. Further, the clumps were tested for smell and for strength of the clump as described above.

### Part 4

During the fourth part of the trial, a mixture of 50% zeolite clumping litter with 50% bentonite clumping litter was used. Bentonite clumping litter was added to the box until the mixture was 70% bentonite clumping litter and 30% zeolite clumping litter. All clumps were removed, weighed, measured, and stored. Further, the clumps were tested for smell and for strength of the clump as described above.

### Results

### Part 1

Following a two to 24 hour period, the zeolite litter clumps had no detectible odor six inches from the clumps. If the clump was less than two hours old there was a slight odor. The zeolite clumping litter had minimal dust from filling the box to removing the clumps. The particle size used was a 20×50 mesh which is considerably finer than the bentonite clumping litter. The zeolite clumps weighed an average of 120 grams each. The average size was 3″×2″. The color was a whitish tan. The zeolite clumps had a tendency to remain as individual clumps. There was only occasional amalgamation of the zeolite clumps. The mass of any amalgamated zeolite clumps was considerably less than the amalgamated bentonite clumps. No extra effort was required to remove the amalgamated clumps. Furthermore, when stored outside, the zeolite clumps maintained their strength and integrity after approximate one week of sunshine, wind and rain.

### Part 2

Following a two to 24 hour period, the bentonite litter clumps had a slight odor six inches from the clumps. If the clump was less than two hours old there was a noticeable odor. The bentonite clumping litter had significant dust from filling the box to removing the clumps. The bentonite clumps weighed an average of 151 grams each. The average size was 3^{1/8}″×2^{3/4}″. The color was a brownish gray. A noticeable aspect of the bentonite clumping litter was a tendency for the clumps to meld together making very large clumps. Therefore, removal of the amalgamated clumps was more difficult due to their size and weight. When stored outside, the bentonite clumps disintegrated after approximate one week of sunshine, wind and rain.

### Part 3

During the choice trial, the ratio of zeolite clumps to bentonite clumps was five to one (5:1), regardless of the positioning of the boxes. These data indicate that the cat selected the zeolite-containing litter 5 times more often than it selected the bentonite-containing litter.

### Part 4

The addition of zeolite clumping letter to the bentonite clumping litter (30%:70% by weight) relative was observed to improve the bentonite clumping litter by reducing the size of the clumps, reducing the odor of the clumps, and increasing the durability of the clumps.

### Conclusions from Study

The comparison of zeolite clumping litter and bentonite clumping litter has demonstrated the zeolite clumping litter has superior properties as a clumping cat litter. The odor control of the zeolite-containing litter was noticeably improved over the bentonite-containing litter. The fugitive dust in the zeolite product was measurably less than that of the bentonite product. Also, handling of the clumps for disposal was more easily accomplished with the zeolite clumping litter compared to the bentonite clumping letter.

In addition, on a pound per pound basis, the zeolite clumping litter, prior to use by the animal, provides 20% more volume than bentonite clumping litter (8 lb of zeolite litter=10 lb of bentonite litter). The zeolite clumps utilize 20% less material than the bentonite clumps. An average zeolite clump weighs 120 grams. An average bentonite clump weighs 151 grams.

The zeolite clumping litter is 40% more effective than the bentonite clumping litter. This is because there is: a) 20% more volume by weight with zeolite-containing litter compared to the bentonite-containing litter; and b) 20% less zeolite-containing litter used per clump of zeolite litter versus the bentonite-containing litter (20%+20%=40%). The result is a positive net benefit of bulk density and absorbency when using zeolite clumping litter.

For transitioning from a bentonite clumping litter to a zeolite clumping litter the compatibility is such that one can simply begin to add the zeolite litter to any existing bentonite litter until it becomes the desire ratio of bentonite to zeolite clumping litter, up to 100% zeolite clumping letter.

The zeolite clumping litter was preferred by the cat over bentonite clumping litter. In addition, there was less spillage around the cat box, after cat use, using the finer granulation of the zeolite litter compared to the bentonite litter.

Furthermore, there is a substantial environmental reward in utilizing zeolite clumping litter. The zeolite clumping letter weighs less and has less volume compared to the bentonite clumping litter and provides better results, as described above. This translates into less packaging for the litter, less volume for transportation and storage purposes and less disposal volumes. These environmental rewards create exceptional value. An additional positive environmental impact is achieved at landfill disposal sites, because of the natural properties of the zeolite it absorbs and adsorbs toxins, thereby locking up toxins in the landfill.

It will be appreciated by those skilled in the relevant arts, from a reading of the disclosure, that various changes in form and detail can be made without departing from the true scope of the invention in the appended claims.

1. A clumping animal litter composition comprising zeolite, a surface-active agent and a clumping agent.

2. The composition of claim 1, wherein the zeolite is Analcime, Apophyllite, Chabazite, Clinoptilolite, Epistilbite, Faujasite, Gmelinite, Heulandite, Laumontite, Merlinoite, Mesolite, Mordenite, Natrolite, Scolecite, Stellarite, Stilbite, Thompsonite or combinations thereof.

3. The composition of claim 1, wherein the zeolite is Clinoptilolite.

4. The composition of claim 1, wherein the zeolite has a purity of between about 50% and about 98%.

5. The composition of claim 1, wherein the zeolite has a purity of between about 96% and about 98%.

6. The composition of claim 1, wherein the zeolite has a purity of about 96%.

7. The composition of claim 1, wherein the zeolite has a gradation of −8+50 mesh.

8. The composition of claim 1, wherein the zeolite has a gradation of −20+50 mesh.

9. The composition of claim 1, wherein the zeolite has less than about 3% fines.

10. The composition of claim 1, wherein the zeolite has a moisture content of about 1% to about 5%.

11. The composition of claim 1, wherein the zeolite has a moisture content of about 4% to about 5%.

12. The composition of claim 1, wherein the zeolite has a moisture content of between greater than 5% and about 8%.

13. The composition of claim 1, wherein the zeolite is present at a weight percent of between about 50% and about 98%.

14. The composition of claim 1, wherein the zeolite is present at a weight percent of between about 90% and about 98%.

15. The composition of claim 1, wherein the zeolite is present at a weight percent of about 92%.

16. The composition of claim 1, wherein the surface-active agent is sodium sulfate, potassium sulfate, sodium phosphate dibasic, sodium phosphate monobasic, sodium pyrophosphate, sodium carbonate, potassium stearate, aluminum potassium sulfate or aluminum sulfate.

17. The composition of claim 1, wherein the surface-active agent is potassium sulfate.

18. The composition of claim 1, wherein the surface-active agent is sodium sulfate.

19. The composition of claim 1, wherein when the zeolite has a moisture content of greater than 5%, the sodium sulfate is anhydrous sodium sulfate.

20. The composition of claim 1, wherein the surface-active agent is present at a weight percent of between about 1% and about 5%.

21. The composition of claim 1, wherein the surface-active agent is present at a weight percent of about 2%.

22. The composition of claim 1, wherein the clumping agent is psyllium, agar, algin, carrageenan, Cydonia, guar gum, gum arabic, gum ghatti, gum tragacanth, karaya gum, larch gum, locust bean gum, pectin, Plantago, quince seed gum, tamarind gum, xanthan gum or combinations thereof.

23. The composition of claim 1, wherein the clumping agent is psyllium.

24. The composition of claim 1, wherein the psyllium has purity of about 70% to about 95%.

25. The composition of claim 1, wherein the psyllium has a mesh size of 40−.

26. The composition of claim 1, wherein the clumping agent is present at a weight percent between about 1% and about 7%.

27. The composition of claim 1, wherein the clumping agent is present at a weight percent of about 2%.

28. The composition of claim 1, further comprising a fragrance.

29. A clumping animal litter composition comprising by weight about 2% sodium sulphate, about 2% psyllium, about 4% water and about 92% zeolite.

30. A clumping animal litter composition comprising by weight about 1% anhydrous sodium sulfate, about 2% psyllium, about 6% water and about 91% zeolite.

31. The clumping animal litter composition of claim 29, wherein the zeolite has purity of 96%.

32. The clumping animal litter composition of claim 29, wherein the zeolite has a −20+50 gradation.

33. The clumping animal litter composition of claim 29, wherein the zeolite has 3% or less fines.

34. The composition of claim 1, wherein the composition is cat litter.

35. The clumping animal litter of claim 1, further comprising an additional animal litter.

36. The clumping animal litter of claim 35, wherein the additional animal litter is a bentonite-containing animal litter.

37. A method of making a clumping animal litter composition, the method comprising:
(a) surface-coating zeolite with a surface-active agent; and
(b) adding a clumping agent to the surface-coated zeolite produced in step (a).

38. The method of claim 37, wherein the surface-active agent is coated onto the zeolite using a sprayer.

39. The method of claim 37, wherein during step (a) the zeolite and surface-active agent are mixed by agitation.

40. The method of claim 37, wherein during step (b) the surface-coated zeolite and clumping agent are mixed by agitation.
